(19) United States
(12) Patent Application Publication
(10) Pub. No.: US 2003/0144615 A1
(43) Pub. Date: Jul. 31, 2003

(54) Rotating and vibrating massage shower nozzle

(76) Inventor: Chun-Kuang Lin, Taiping City (TW)

Correspondence Address: Charles E. Baxley, Hart, Baxley, Daniels & Holton, Fifth Floor, 59 John Street, New York, NY, 10038, US

(21) Appl. No.: 10/056,624

(22) Filed: Jan. 28, 2002

(51) Int. Cl. A61H 7/00; A61H 9/00

(52) U.S. Cl. 601/112

(57) ABSTRACT

A rotating and vibrating massage shower nozzle comprised of a first transmission shaft and a flexible transmission cable. The first transmission shaft rotates a drive gear, a driven gear, and a second transmission shaft. The second transmission shaft has a drive ring gear installed on it that impels a bevel gear train or an eccentric cylinder, with the said bevel gear train controlling the revolution of a rotary output coupling such that a bathing accessory mounted on it is spun and the said imbalanced action of the eccentric cylinder effectively generates vibrations for massage applications.

### BACKGROUND OF THE INVENTION

1) Field of the Invention

The invention herein relates to handheld shower nozzles utilized for bathing, specifically a rotating and vibrating massage shower nozzle equipped with an interchangeable brush head, massage head, or other accessory attachment and that is capable of being switched between rotation and vibration modes.

2) Description of the Prior Art

Conventional shower nozzles are typically capable of only converting tap water into a cascading drizzle, with the user turning a control on the shower nozzle to adjust the flow intensity as required. Many manufacturers have equipped such shower nozzles with massage capability, but it is commonly known that there are limits as to how much massage performance is achievable and, furthermore, water is wasted in the process.

### SUMMARY OF THE INVENTION

The primary objective of the invention herein is to provide a rotating and vibrating massage shower nozzle in which a bathing accessory (such as a brush or massage head) can be interchangeably attached to the shower nozzle and, furthermore, the shower nozzle is capable of controlling the rotation or vibration of the said bathing accessory to effectively achieve cleaning, massaging, and the promotion of blood circulation.

To achieve the said objective, the technology applied includes:

A first transmission shaft and a flexible transmission cable; the said first transmission shaft sequentially rotates a drive gear, a driven gear, and a second transmission shaft; the said second transmission shaft has a drive ring gear installed on it that impels a bevel gear train or an eccentric cylinder, with the said bevel gear train controlling the revolution of a rotary output coupling such that the bathing accessory mounted on it is spun and the said imbalanced action of the eccentric cylinder effectively generates vibrations for massage applications.

### BRIEF DESCRIPTION OF THE DRAWINGS

FIG. 1 is an isometric drawing of the invention herein.

FIG. 2 is an exploded drawing of the invention herein.

FIG. 3 is a cross-sectional drawing of the internal structure of the invention herein.

FIG. 4 is a cross-sectional drawing of the rotating shower nozzle structure.

FIG. 5 is a magnified cross-sectional drawing of FIG. 4 as viewed from the perspective of line 5-5.

FIG. 6 is a cross-sectional drawing of the invention herein during rotation and vibration.

FIG. 7 is magnified, partial cross-sectional drawing of FIG. 6 as viewed from the perspective of line 7-7.

FIG. 8 is partial cross-sectional drawing of the invention herein depicting the shower nozzle spray power.

### DETAILED DESCRIPTION OF THE INVENTION

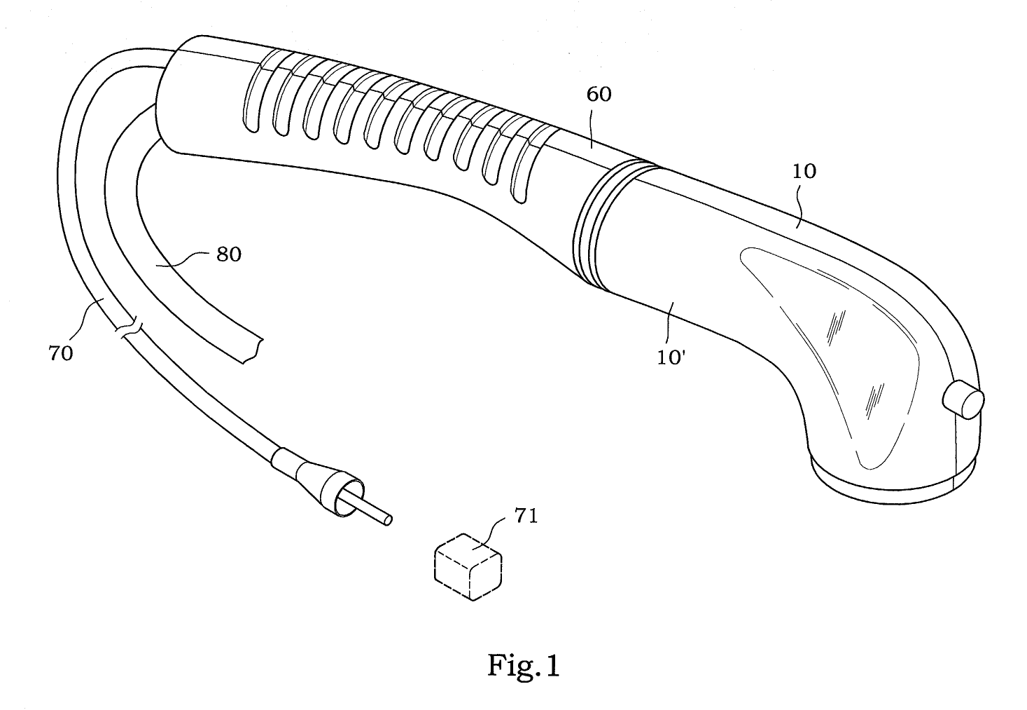

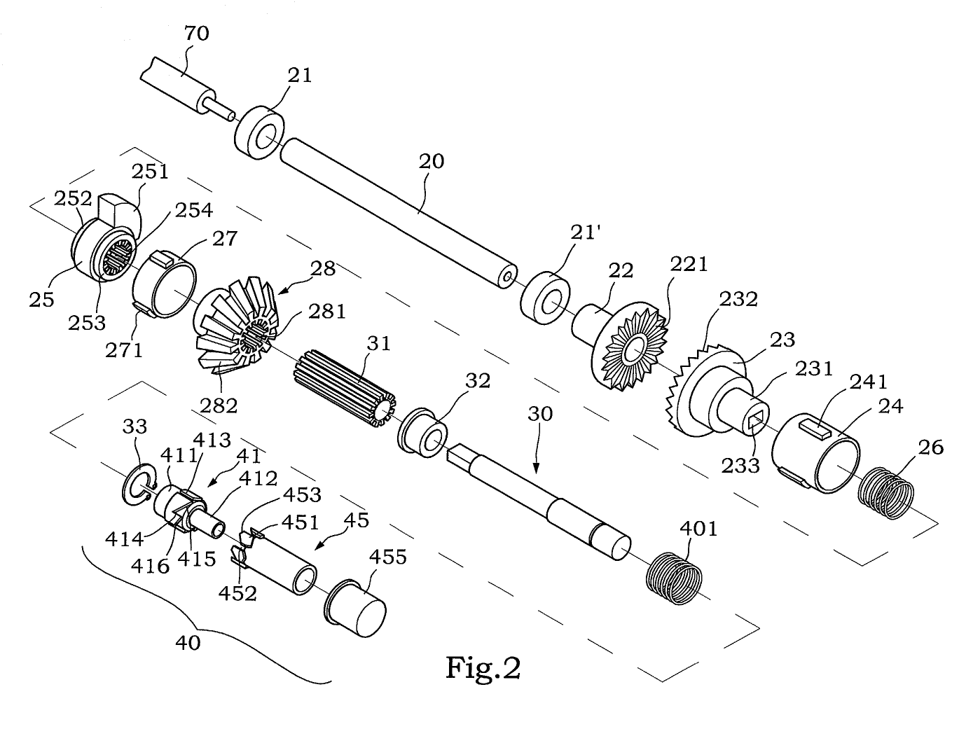

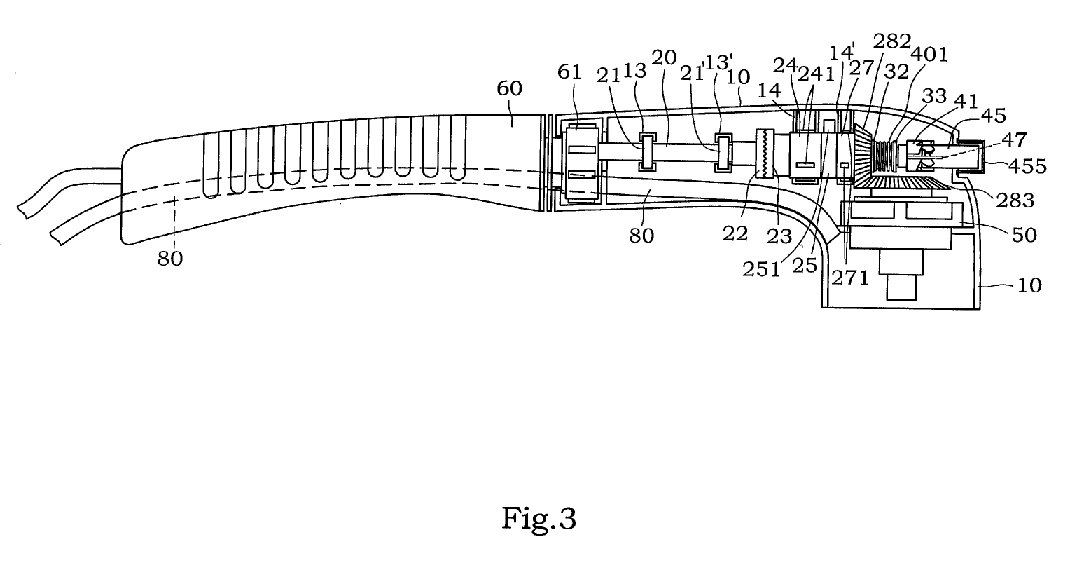

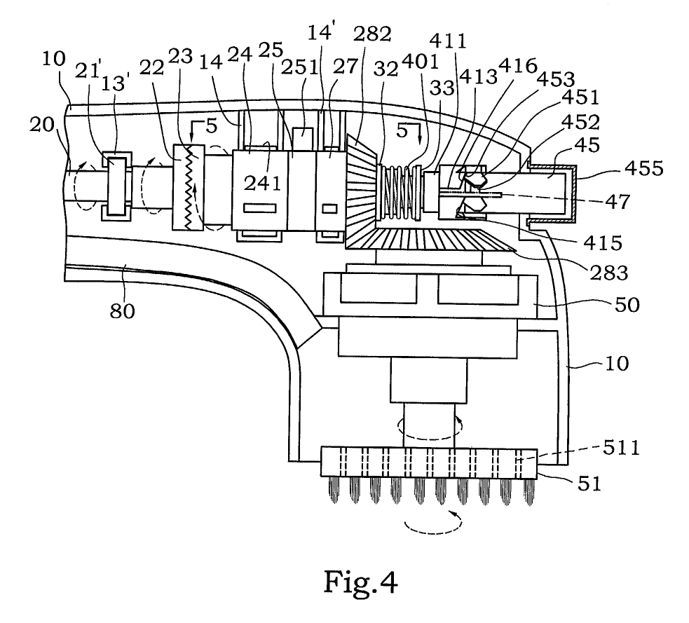

Referring to FIG. 1, FIG. 2, FIG. 3, and FIG. 4, the invention herein is comprised of:

A first and a second case half 10 and 10′ that are assembled together to form a hollow containment space.

A first transmission shaft 20 situated in the said containment space has two bearings 21 and 21′ for balanced rotation, with the said two bearings 21 and 21′ respectively seated in bearing mounts 13 and 13′.

A drive gear 22, one end of which is tightly sleeved onto the said first transmission shaft 20, with the other end consisting of a toothed surface 221.

A driven gear 23 having a stepped stem 231, with a toothed surface 232 at one end that is enmeshed with the toothed surface 221 of the said transmission shaft 20; and the said driven gear 23 has a rectangular hole 233 formed in its other end.

A first locating ring 24 consisting of a hollow annular structure having a plurality of projecting blocks 24 along its outer surface and that is fitted into a first ring mount 14, with the stem 231 of the said driven gear 23 inserted into the said first locating ring 24.

An eccentric cylinder 25 having a counterweight lobe 251 disposed on its outer surface as well as a first sleeve section 252 and a second sleeve section 253 at it two ends; the said first sleeve section 252 is inserted into the said first locating ring 24; and internal splines 254 are formed lengthwise along its interior.

A packing spring 26 having one end inserted into the stem 231 of the said driven gear 23 and the other end placed against the first sleeve section 252 of the said eccentric cylinder 25, and which is situated inside the said first locating ring 24.

A second locating ring 27 consisting of a hollow annular structure, one end of which accommodates the insertion of the second sleeve section 253 of the said eccentric cylinder 25, having a plurality of projecting blocks 271 along its outer surface that provides for fitting into a second ring mount 14′ of the case.

A bevel gear train 28 consisting of a first gear 282 and a second gear 283; one end of the first gear 282 is inserted into the said second locating ring 27 and internal splines 281 are formed lengthwise along its interior; and the second gear 283 is enmeshed to the first gear 282.

A second transmission shaft 30, one end of which is inserted through the said first gear 282, second locating ring 27, eccentric cylinder 25, and first locating ring 24 and then snugged into the rectangular hole 233 of the said driven gear 23, with the said rectangular hole 233 having an appropriate depth that provides for the linear travel of the said second transmission shaft 30; the said second transmission shaft 30 is inserted into a drive ring gear 31 and the said drive ring gear 31 is enmeshed with the internal splines 281 inside a minimum of one said first gear 282; and the said second transmission shaft 30 has a stop collar 32 that mounts it to the end section of the said first gear 282.

A spring-loaded shifting mechanism 40 consisting of a spring 401, a transmission column 41, and a plunger column 45; the said spring 401 is situated such that it is against the said stop collar 32 and its other end is against a C-shaped clip ring 33 on the second transmission shaft 30.

The said transmission column 41 has a tubular extremity 411 of reduced diameter at one end that provides for insertion into and against the end section of the second transmission shaft 30, enabling the transmission column 41 to linearly push the said second transmission shaft 30, but remain capable of free rotation at the shaft end section; the said transmission column 41 has a rod-like tip 412 of a narrowed diameter extending from its other end that is inserted into the said plunger column 45; the said transmission column 41 has a plurality of guide slots 413 disposed along its outer periphery, a detent slot 414 of a bevel gear-profiled design situated between each guide slot 413, a first slanted edge 415, and a second slanted edge 416.

The said plunger column 45 is crowned with a plurality of spurs 451 protruding at intervals that correspond to the end section of the said transmission column 41, a guide slot 452 is formed between each spur 451, and an angular slip actuation edge 453 is disposed on its open end; the other end of the plunger column 45 extends outside the said case halves 10 and 10′ and is covered with a soft plastic cap 451.

The said shower nozzle case halves 10 and 10′ have a plurality of internally protruding slide rails 47 that correspond to the guide slots 413 situated in the said spring-loaded shifting mechanism 40. When assembled, the guide slots 413 and 452 of the said transmission column 41 and plunger column 45 are set onto the said slide rails 47, at which time the first and second slanted edges 415 and 416 of the said transmission column 41 are respectively positioned against the slip actuation edge 453 of the said plunger column 45; the tensile force of the said spring 401 exerted against the second transmission shaft 30 is transferred to the said transmission column 41 and plunger column 45 such that the plunger column 45 end section is pushed out of the case halves 10 and 10′.

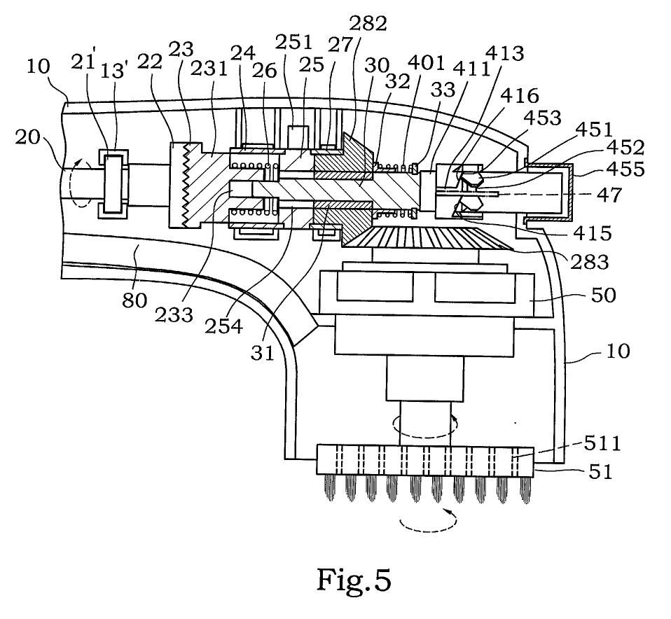

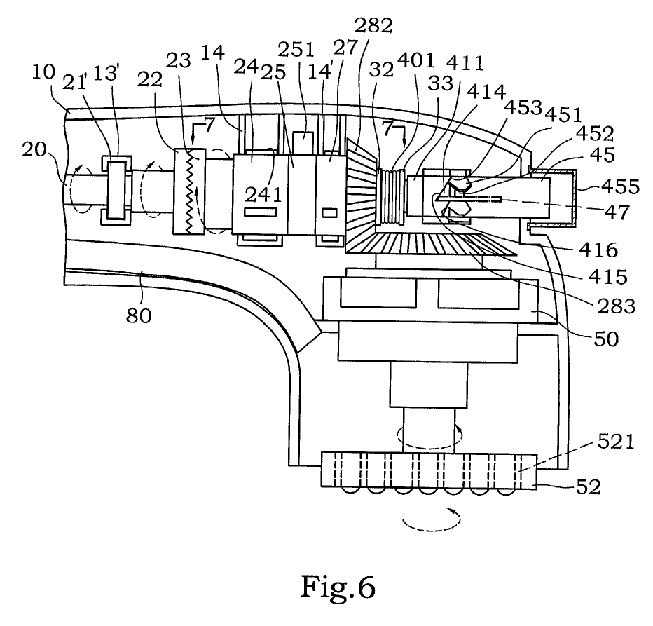

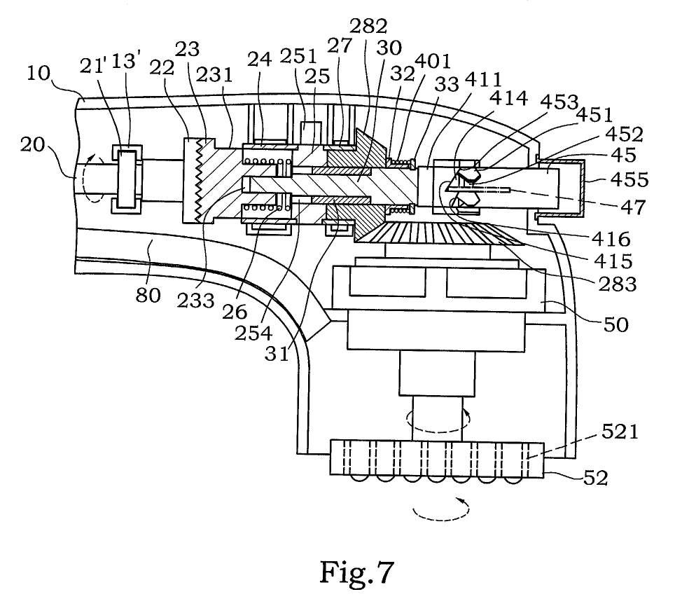

A rotary output coupling 50, one end of which is connected to the second gear 283 of the said bevel gear train 28, with a bathing accessory (such as a brush head 51 or a massage head 52) attached to its other end (as shown in FIG. 5, FIG. 6, and FIG. 7).

A handle 60, the end portion of which is sleeved in an elastomeric damper grip 61 that minimizes vibration.

A flexible transmission cable 70 having a soft protective lining on its exterior; one end of the said flexible transmission cable 70 is connected to a motor 71, while the other end is inserted through the said handle 60 and the said damper grip 61, and then conjoined to the said first transmission shaft 20.

A water hose 80, one end of which is attached to a water source, with the other end is inserted through the said handle 60 and the said damper grip 61 into the said rotary output coupling 50; after the faucet is opened, water immediately flows into the brush head 51 or massage head 52 attachment section and is discharged from the orifices 511 and 521.

As indicated in FIG. 6 and FIG. 7, when the user depresses the said soft plastic cap 451, the said plunger column 45 is moved inward, the said transmission column 41 pushes the said second transmission shaft 30, the said second transmission shaft 30 compresses the said spring 401 by means of its C-shaped clip ring 33, and the guide slots 413 the said transmission column 41 travel along the said slide rails 47; the first slanted edge 415, the second slanted edge 416, and the slip actuation edge 453 are articulated in a coordinated movement by their angular faces and the rebound tension of the spring 401, thereby causing the said transmission column 41 to rotate until the said slide rails 47 become engaged in the said detent slots 414 and the said second transmission shaft 30 is pushed inward and positioned such that a section of the drive ring gear 31 on it is enmeshed with the internal splines 281 of the first gear 282 and another section is enmeshed with the internal splines 254 of the eccentric cylinder 25. In this state, the motor 71 is switched on and the said flexible transmission cable 70 rotates the said first transmission shaft 20, drive gear 22, driven gear 23, and the second transmission shaft 30, with the drive ring gear 31 then causing the rotation of the said first gear 282 and eccentric cylinder 25. At the same time, the said first gear 282 rotates the said second gear 283, rotary output coupling 50, and the brush head 51 or massage head 52, thereby enabling the brush head 51 or massage head 52 to spin and be used for cleansing. Due to the effect of the counterweight lobe 251 while the eccentric cylinder 25 is rotating, the shower nozzle structure vibrates to provide for massaging applications.

By depressing the plunger column 45 once again, the said plunger column 45 is pushed against the said transmission column 41 until the said detent slots 414 are disengaged from the said slide rails 47, the transmission column 41 rotates to the next guide slot 413 relative to the said slide rails 47, and the said second transmission shaft 30 pushes the said transmission column 41 along the said slide rails 47 as the said spring 401 is released, thereby enabling the end section of the plunger column 45 to extend outside the said case halves 10 and 10′; in this state, since the drive ring gear 31 of the second transmission shaft 30 recedes back and is disengaged from the internal splines 254 of the eccentric cylinder 25, and is only enmeshed with the first gear 282 and the internal splines 281 of the said bevel gear train 28, the first gear 282 of the bevel gear train 28 is rotated by the second transmission shaft 30 and the said second gear 283 rotates the said rotary output coupling 50 as well as the brush head 51 or massage head 52 attached to it, which is among the shower nozzle rotation modes of the invention herein.

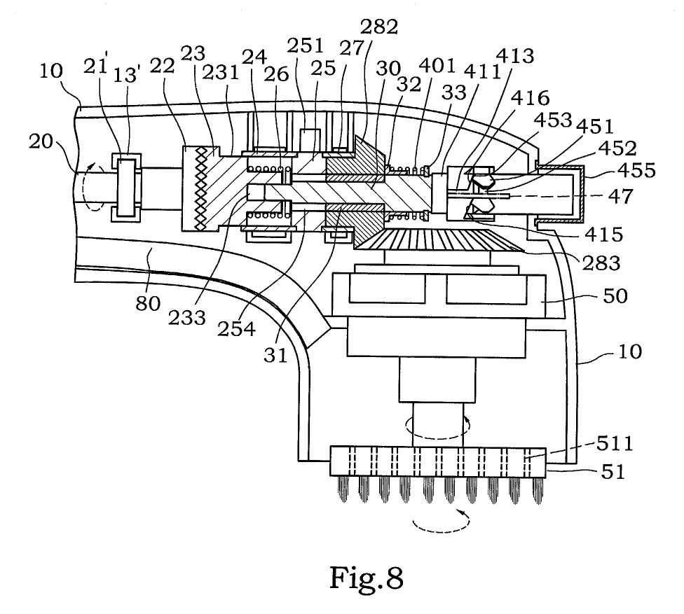

As indicated in FIG. 8, invention herein has a spray force maintenance device consisting of the driven gear 23 and the packing spring 26. When any component behind the drive gear 22 cannot be impelled, the second transmission shaft 30 is incapable of rotation and pressure is transferred to the said driven gear 23, at which time since the driven gear 23 cannot be smoothly rotated by the drive gear 22, the interlocking enmeshment causes the linear flexile movement of the driven gear 23 inside the first locating ring 24, resulting in the production of an impact sound by the said drive gear 22 that prompts the user of the mechanical problem and that utilization should be stopped.

1. A rotating and vibrating massage shower nozzle comprised of:
A first and a second case half that are assembled together to form a hollow containment space and in which a water hose is clamped.
A first transmission shaft situated within the containment space and rotated by a motorized component.
A drive gear, one end of which is tightly sleeved onto the said first transmission shaft, with the other end consisting of a toothed surface.
A driven gear having a toothed surface at one end that is enmeshed with the toothed surface of the said transmission shaft.
A bevel gear train consisting of a first gear and a second gear; the said first gear is rotated by the said driven gear and the said second gear is enmeshed to the said first gear.
A rotary output coupling, one end of which is connected to the said second gear of the said bevel gear train, with a bathing accessory attached to its other end.

2. As mentioned in claim 1 of the rotating and vibrating massage shower nozzle of the invention herein, the said driven gear and the said first gear have installed between them a first and a second locating ring that are fitted into the inner walls of the said first and second case halves; the shaft sections of the said driven gear and the said first gear are respectively inserted into the said first and second locating ring; and the two ends of an eccentric cylinder, consisting of an annular structure having a counterweight lobe disposed on its outer surface and internal splines formed lengthwise along its inside, are respectively inserted into ends of the said first and a second locating ring.

3. As mentioned in claim 2 of the rotating and vibrating massage shower nozzle of the invention herein, the said driven gear and the said eccentric cylinder have a packing spring installed between them.

4. As mentioned in claim 2 of the rotating and vibrating massage shower nozzle of the invention herein, the said first gear and the said eccentric cylinder each have internal splines formed lengthwise along the interior walls of their center shaft holes.

5. As mentioned in claim 4 of the rotating and vibrating massage shower nozzle of the invention herein, the present invention is also comprised of a second transmission shaft, one end of which is inserted through the said first gear and the said eccentric cylinder, and then snugged into the said driven gear; the said second transmission shaft is inserted into a drive ring gear and the said drive ring gear is enmeshed with the said internal splines 281 inside a minimum of one said first gear.

6. As mentioned in claim 5 of the rotating and vibrating massage shower nozzle of the invention herein, the said second transmission shaft has a spring-loaded shifting mechanism disposed at its end section that enables the user to flexibly move the said second transmission shaft back and forth for massage control.

7. As mentioned in claim 6 of the rotating and vibrating massage shower nozzle of the invention herein, the controlling said spring-loaded shifting mechanism pushes the said second transmission shaft towards the said eccentric cylinder such that a section of its said drive ring gear is enmeshed with the said internal splines of the said first gear and another section is enmeshed with the said internal splines of the said eccentric cylinder.

8. As mentioned in claim 6 of the rotating and vibrating massage shower nozzle of the invention herein, the controlling said spring-loaded shifting mechanism pushes the said second transmission shaft away from the said eccentric cylinder such that the said drive ring gear of the said second transmission shaft is only engaged with the said internal splines of the said first gear.

9. As mentioned in claim 6 of the rotating and vibrating massage shower nozzle of the invention herein, the said spring-loaded shifting mechanism consists of a spring, a transmission column, and a plunger column; the two ends of the said spring are respectively against a stop collar and a C-shaped clip ring on the said second transmission shaft.
One end of the said transmission column provides for insertion into and against the end section of the said second transmission shaft, enabling the transmission column to linearly push the said second transmission shaft, but remain capable of free rotation at the shaft end section; the other end of the said transmission column is inserted into the said plunger column; the said transmission column has a plurality of guide slots disposed along its outer periphery, a detent slot of a bevel gear-profiled design situated between each guide slot, a first slanted edge, and a second slanted edge.
The said plunger column is crowned with a plurality of spurs protruding at intervals that correspond to the end section of the said transmission column, a guide slot is formed between each spur, and an angular slip actuation edge is disposed on its open end; and the other end of the said plunger column extends outside the said shower nozzle case halves.
The said shower nozzle case halves have a plurality of internally protruding slide rails 47 that correspond to the said guide slots of the said transmission column.

10. As mentioned in claim 9 of the rotating and vibrating massage shower nozzle of the invention herein, the end section of the said plunger column extending from the said case halves is covered with a soft plastic cap.

11. As mentioned in claim 9 of the rotating and vibrating massage shower nozzle of the invention herein, when the said guide slots of the said transmission column and the said plunger column are set onto the said slide rails, the said plunger column end section is pushed out of the said case halves, and the said drive ring gear of the said second transmission shaft is only engaged with the said internal splines of the said first gear.

12. As mentioned in claim 9 of the rotating and vibrating massage shower nozzle of the invention herein, when the said guide slots of the said transmission column and the said plunger column are set onto the said slide rails, the said second transmission shaft is pushed towards the said eccentric cylinder and its said drive ring gear is enmeshed with the said internal splines of the said first gear and the said internal splines of the said eccentric cylinder.

13. As mentioned in claim 1 of the rotating and vibrating massage shower nozzle of the invention herein, the said first transmission shaft has two bearings utilized for balanced rotation and the said bearings are seated inside the said first and second case halves.

14. As mentioned in claim 1 of the rotating and vibrating massage shower nozzle of the invention herein, the said bathing accessory is a brush head.

15. As mentioned in claim 1 of the rotating and vibrating massage shower nozzle of the invention herein, the said bathing accessory is a massage head.

16. As mentioned in claim 1 of the rotating and vibrating massage shower nozzle of the invention herein, the end portion of the said first and a second case halves is sleeved in an elastomeric damper grip.

17. As mentioned in claim 1 of the rotating and vibrating massage shower nozzle of the invention herein, the power transfer component of the said first transmission shaft is a flexible transmission cable.
